(19) United States
(12) Patent Application Publication
(10) Pub. No.: US 2026/0034509 A1
(43) Pub. Date: Feb. 5, 2026

(54) ROTATING PACKED BED REACTORS

(71) Applicant: Schlumberger Technology Corporation, Sugar Land, TX (US)

(72) Inventors: Eric LAVRUT, Clamart (FR); Z. Frank ZHENG, Sugar Land, TX (US); Sara ESCANERO, Sugar Land, TX (US); Gocha CHOCHUA, Sugar Land, TX (US); Shu PAN, Calgary (CA)

(21) Appl. No.: 19/139,353

(22) PCT Filed: Jun. 21, 2024
(86) PCT No.: PCT/US2024/035043

§ 371 Date: Jun. 15, 2025

Related U.S. Application Data
(60) Provisional application No. 63/509,287, filed on Jun. 21, 2023.
(60) Provisional application No. 63/509,414, filed on Jun. 21, 2023.

(51) Int. Cl. B01D 53/78; B01D 53/14; B01D 53/18; B01D 53/62

(52) U.S. Cl. CPC B01D 53/78; B01D 53/1475; B01D 53/18; B01D 53/62; B01D 2252/204; B01D 2257/504

(57) ABSTRACT

An apparatus for a rotating packed bed reactor (RPB) that may be used to increase the mass-transfer rate between materials, such as a gas and a liquid, through the RPB. The RPB includes a housing, a motor, and a rotor disposed within the housing and operatively connected with the motor. The rotor includes a permeable packing configured to facilitate contact between a liquid and a gas passing through the permeable packing. The rotor includes a heat sink in contact with the permeable packing and configured to transfer heat away from the permeable packing. The heat sink includes a heat rate transfer gradient in a radially inward direction between an outer circumferential surface of the permeable packing and a central axis of the permeable packing.

### CROSS-REFERENCE TO RELATED APPLICATIONS

The present application claims priority to and the benefit of U.S. Provisional Patent Application No. 63/509,287 entitled “Rotating Packed Bed Reactor” filed Jun. 21, 2023 and U.S. Provisional Patent Application No. 63/509,414 entitled “Rotating Packed Bed Reactors” filed Jun. 21, 2023, the disclosures of which are incorporated herein by reference in their entirety.

### BACKGROUND OF THE DISCLOSURE

Separation processes play a vital role in heavy processing, chemical, petrochemical, and pharmaceutical industries. Separation processes are used, for example, to extract and dispose of atmospheric gas pollutants (e.g., flute gases), such as sulfur dioxide, hydrogen sulfide, nitrous oxide, ammonia, various hydrocarbons, and carbon dioxide, which contribute to global warming. Processes that use liquids containing such dissolved gases can lead to deterioration of end products as well as damage to equipment performing such processes.

Packed bed columns (PBCs) are often used to perform separation processes. PBCs use Earth's gravity to cause a liquid to flow contra directionally to a stream of gas. In PBCs, liquid-gas contact area and gravity determine achievable liquid and gas throughputs and mass-transfer rates that, in turn, stipulate the relatively large size and bulkiness of the PBCs for industrial-scale facilities. Example PBCs include distillation columns, absorption columns, stripping columns, and contacting columns.

Rotating packed bed (RPB) reactors, which are more compact than the packed bed columns, can instead be used to perform separation processes to overcome low mass-transfer rates of conventional PBCs. RPB reactors, which are also known as HiGees (or high gravity reactors), utilize rotation to generate centrifugal forces that are hundreds of times greater than the force of gravity, permitting the use of permeable packings having larger surface areas to increase mass-transfer rates. Under the high centrifugal forces formed by RPB reactors, the liquid flows along the permeable packing as a thin film, resulting in an increase in the liquid-side mass-transfer coefficient, which can be several times higher than in conventional PBCs. As a result, RPB reactors can be many times smaller than conventional PBCs.

The compactness of RPB reactors is a sought-after parameter governing applicability of the RPB reactors. However, providing pollutant capture services for modern industrial-scale power plants utilizing fossil fuels can still utilize hundreds of RPB reactors per 1 Gigawatt of generated energy, resulting in a pollutant capture facility having a size comparable with the power plant itself. Although RPB reactors are successfully operating in the industry, internal processes of RPB reactors are not fully understood, and their architecture and optimal design parameters are still under research and development. The existing research and development are governed not just by diversity and range of operational parameters (e.g., gas sweetening, oxygen removal, carbon removal, etc.), but are also aimed at providing RPB reactors with a more efficient and compact design, such as by increasing throughput (i.e., mass transfer or flow rate) and decreasing physical size (i.e., footprint).

### BRIEF SUMMARY

In some embodiments, the RPB includes a housing, a motor, and a rotor disposed within the housing and operatively connected with the motor. The rotor includes a permeable packing configured to facilitate contact between a liquid and a gas passing through the permeable packing. The rotor includes a heat sink in contact with the permeable packing and configured to transfer heat away from the permeable packing. The heat sink includes a heat rate transfer gradient in a radially inward direction between an outer circumferential surface of the permeable packing and a central axis of the permeable packing.

In some embodiments, the RPB includes a housing, a motor, and a rotor disposed within the housing and operatively connected with the motor. The rotor is configured to rotate about a central axis. The rotor includes a permeable packing configured to facilitate contact between a liquid and a gas passing through the permeable packing. The rotor includes a plurality of impeller blades configured to force the liquid through the permeable packing in a radially outward direction with respect to the central axis.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic sectional side view of at least a portion of an example implementation of apparatus according to one or more aspects of the present disclosure.

FIG. 2 is a sectional axial view of the apparatus shown in FIG. 1.

FIG. 3 is a schematic sectional side view of a portion of an example implementation of apparatus according to one or more aspects of the present disclosure.

FIG. 4 is a schematic sectional side view of a portion of an example implementation of apparatus according to one or more aspects of the present disclosure.

FIG. 5 is a schematic sectional side view of a portion of an example implementation of apparatus according to one or more aspects of the present disclosure.

FIG. 6 is a schematic sectional side view of a portion of an example implementation of apparatus according to one or more aspects of the present disclosure.

FIG. 7 is a schematic sectional side view of a portion of an example implementation of apparatus according to one or more aspects of the present disclosure.

FIG. 8 is a sectional axial view of the apparatus shown in FIG. 7.

FIG. 9 is a schematic sectional axial view of a portion of an example implementation of apparatus according to one or more aspects of the present disclosure.

FIG. 10 is a schematic sectional axial view of a portion of an example implementation of apparatus according to one or more aspects of the present disclosure.

FIG. 11 is a sectional side view of the apparatus shown in FIG. 10.

FIG. 12 is a schematic sectional side view of a portion of an example implementation of apparatus according to one or more aspects of the present disclosure.

FIG. 13 is an enlarged view of a portion of an example implementation of the apparatus shown in FIG. 12.

FIG. 14 is an enlarged view of a portion of another example implementation of the apparatus shown in FIG. 12.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

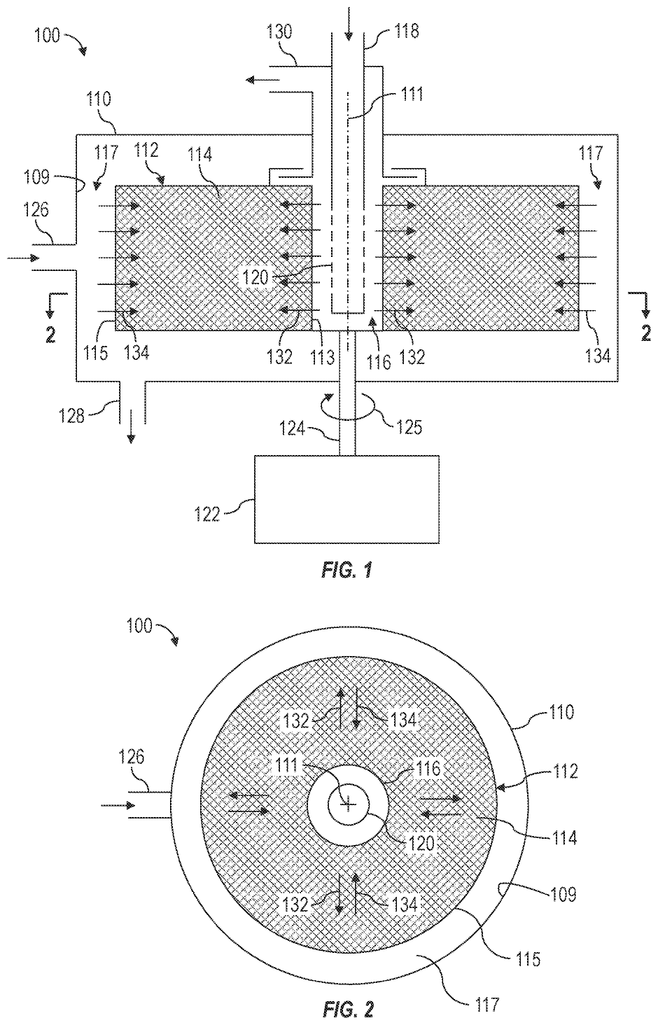

FIG. 1 is a schematic sectional side view of at least a portion of an RPB reactor 100 according to one or more aspects of the present disclosure. FIG. 2 is a sectional axial view of the RPB reactor 100 shown in FIG. 1. The RPB reactor 100 may comprise a housing 110 (also referred to as a casing or collector) containing a rotor 112 (i.e., a rotating packed bed) configured for rotation within and with respect to the housing 110. The rotor 112 may be rotatable about its central axis 111, as indicated by arrow 125. The rotor 112 may be mechanically connected to a motor 122 via a shaft 124 or other mechanical connection means extending into the housing 110 through a wall of the housing 110. The motor 122 may be operable to rotate the rotor 112 about the central axis 111. The rotor 112 may comprise a permeable liquid-gas reaction (or contact) region in the form of or otherwise defined by a permeable (or porous) packing 114 having internal and/or external surface areas along which the liquid and gas can flow and contact each other and, thus, facilitate mass transfer between the liquid and gas. The rotor 112 (including the permeable packing 114) may comprise an annular geometry. For example, the rotor 112 (and the permeable packing 114) may comprise an inner circumferential (or radial) surface (or inner circumference) 113 having an inner diameter and defining an axial (or central) space 116 extending axially at least partially through the rotor 112. The axial space 116 may extend along the central axis 111. The rotor 112 (and the permeable packing 114) may further comprise an outer circumferential (or radial) surface (or outer circumference) 115 having an outer diameter and defining an external annular space (or collector area) 117 extending around the rotor 112 between the outer circumferential surface 115 and an inner circumferential surface 109 of the housing 110.

The permeable packing 114 may be or comprise metal or non-metal particles, fillers, beads, or other members (e.g., metal balls, glass balls, metal-oxide particles, ceramic particles, foam particles, etc.) defining gaps or other spaces therebetween that collectively permit passage of liquid and gas therethrough. The permeable packing 114 may also or instead be or comprise metal or non-metal foams having gaps, openings, or other spaces of predetermined size that collectively permit passage of liquid and gas therethrough. The permeable packing 114 may also or instead be or comprise metal or non-metal knitted, fibrous, or woven wire meshes, expanded mesh packings, or other members having openings of predetermined size that collectively permit passage of liquid and gas therethrough. The permeable packing 114 may also or instead be or comprise overlapping or alternating rings, blades, baffles, or other members defining channels, gaps, or other spaces that alternate (or zigzag) in opposing directions and collectively permit passage of liquid and gas therethrough. The permeable packing 114 may also or instead be or comprise a plurality of discs or other members disposed in a concentric and parallel manner, and spaced apart by predetermined distances, thereby defining channels, gaps, or other spaces that collectively permit passage of liquid and gas therethrough. The various particles and members of the permeable packing 114 may comprise surface areas along which the liquid and gas can flow and contact each other and, thus, facilitate mass transfer between the liquid and gas.

The RPB reactor 100 may further comprise a liquid inlet 118 extending into the housing 110 and a liquid outlet 128 extending out of the housing 110. The liquid inlet 118 may be located on an upper side of the housing 110 above the rotor 112 and the liquid outlet 128 may be located on a lower side of the housing 110 below the rotor 112. The liquid inlet 118 may be fluidly connected with a liquid distributor 120 disposed within the axial space 116, thereby facilitating transfer of a liquid from the liquid inlet 118 to the axial space 116. The RPB reactor 100 may further comprise a gas inlet 126 extending into the housing 110 and a gas outlet 130 extending out of the housing 110. The gas inlet 126 may be located on a lateral side of the housing 110, extending through the inner circumferential surface 109 of the housing 110 to fluidly connect a gas source with the annular space 117. The gas inlet 126 may be located along (or adjacent) the outer circumferential surface 115 of the rotor 112 or otherwise fluidly connected with the annular space 117. The gas outlet 130 may be located on an upper side of the housing 110 above the rotor 112. The gas outlet 130 may be fluidly connected with the axial space 116, thereby facilitating transfer of the gas from the axial space 116 to the gas outlet 130 and out of the RPB reactor 100.

During operations of the RPB reactor 100, while the motor 122 rotates the rotor 112 (and the permeable packing 114) about the axis 111, a liquid is transferred (e.g., pumped) into the housing 110 via the liquid inlet 118 and injected into the axial space 116 (also known as the flooding area) via the liquid distributor 120 while a gas is transferred (e.g., pumped) into the annular space 117 via the gas inlet 126. The high centrifugal force (or gravity) field generated by the rotating rotor 112 causes the liquid to flow radially outward through the permeable packing 114, as indicated by arrows 132, while a pressure differential causes the gas to flow radially inward through the permeable packing 114, as indicated by arrows 134. While the liquid and gas flow in opposing directions through the permeable packing 114, the liquid and gas contact each other along outer surfaces of the various particles and/or members forming the permeable packing 114. As the liquid and gas contact each outer, gas components (e.g., carbon dioxide, pollutants) are transferred from the gas to the liquid. After the gas reaches the axial space 116, the gas is transferred out of the housing 110 via the gas outlet 130, and after the liquid reaches the annular space 117, the liquid is transferred out of the housing 110 via the liquid outlet 128. In some embodiments, the liquid absorbs carbon dioxide via chemical absorption from the gas, such that the gas exiting through the gas outlet 130 has a lower concentration of carbon dioxide than the gas entering the gas inlet 126.

In some embodiments, the liquid includes a solvent that is partially miscible with water or immiscible with water. The liquid may include a nitrogenous base, such as an organic amine, a non-organic amine, and one or more of a diluent and water. The nitrogenous base of the NAS may include an amine (e.g., a primary amine, a secondary amine), an amidine, a guanidine (e.g., 1,1,3,3-tetramethylguanidine (“TMG”)), a triazole (e.g., 1,2,3-triazole, 1,2,4-triazole), or combinations thereof. In some embodiments, the nitrogenous base includes a hydrophobic amine. The amine may include one or more of N-methylbenzylamine (NMBA), 2-fluoro-N-methylbenzylamine, 3-fluoro-N-methylbenzylamine, 4-fluoro-N-methylbenzylamine, 3,5-difluorobenzylamine, 1,4-diazabicyclo-undec-7-ene (“DBU”), 1,4-diazabicyclo-2,2,2-octane, piperazine (“PZ”), triethylamine (“TEA”), 1,8-diazabicycloundec-7-ene, monoethanolamine (“MBA”), diethyl amine (“DEA”), ethylenediamine (“EDA”), methyldiethanolamine (MDEA), 2-amino 1-propanol (AMP), 1,3-diamino propane, 1,4-diaminobutane, hexamethylenediamine, 1,7-diaminoheptane, diethanolamine, diisopropylamine (“DIPA”), 4-aminopyridine, pentylamine, hexylamine, heptylamine, octylamine, nonyl amine, decylamine, tert-octylamine, dioctylamine, dihexylamine, 2-ethyl-1-hexylamine, 2-fluorophenethylamine, 3-fluorophenethylamine, 4-fluorophenethylamine, D-4-fluoro-alpha-methylbenzylamine, L-4-fluoro-alpha-methylbenzylamine, imidazole, benzimidazole, N-methyl imidazole, 1-trifluoroacetylimidazole, or combinations thereof. In some embodiments, the hydrophobic amine includes N-methylbenzylamine.

FIGS. 3-5 are schematic sectional side views of example implementations of permeable packings 202, 204, 206, respectively, according to one or more aspects of the present disclosure. Each permeable packing 202, 204, 206 may be or comprise an example implementation of the permeable packing 114 shown in FIGS. 1 and 2, and may comprise one or more features and/or modes of operation of the permeable packing 114. Each permeable packing 202, 204, 206 may be implemented as part of the RPB reactor 100 shown in FIGS. 1 and 2. For example, each permeable packing 202, 204, 206 may be implemented as part of the rotor 112 shown in FIGS. 1 and 2. Accordingly, the following description may refer to FIGS. 1-5, collectively.

Each permeable packing 202, 204, 206 may be or comprise a permeable packing material or members configured to facilitate contact between a liquid and a gas passing therethrough. Each permeable packing 202, 204, 206 may have a porosity or flow rate gradient that decreases in the radially outward direction between the central axis 111 and the outer circumferential surface 115 of the permeable packing 202, 204, 206, as indicated by the arrows 132. Thus, a liquid passing along the permeable packing 202, 204, 206 may be less restricted and flow more freely through the permeable packing 202, 204, 206 near the central axis 111 (and the inner circumferential surface 113) where the centrifugal force is smaller when the rotor 112 is rotating. Conversely, the liquid passing along the permeable packing 202, 204, 206 may be more restricted and flow less freely through the permeable packing 202, 204, 206 near the outer circumferential surface 115 where the centrifugal force is greater when the rotor 112 is rotating.

The permeable packing 202 may be or comprise particulate material having a porosity gradient that decreases in the radially outward direction 132. For example, the particulate material of the permeable packing 202 may decrease in size in the radially outward direction 132, thereby increasingly restricting flow of the liquid through the permeable packing 202 in the radially outward direction 132. The permeable packing 202 may instead be or comprise a mesh (e.g., a wire mesh) having a porosity gradient that decreases in the radially outward direction 132. For example, the mesh may comprise openings that decrease in size (e.g., width, area, etc.) in the radially outward direction 132, thereby increasingly restricting flow of the liquid through the permeable packing 202 in the radially outward direction 132. Additionally, or in the alternative, a density of the permeable packing 202 may increase in the radially outward direction 132. For example, wire mesh of the permeable packing 202 may be radially layered in packing rings having a consistent radial thickness T across the rotor. The number of layers of wire mesh within the thickness T of a packing ring may be greater for a first packing ring at the outer circumferential surface 115 than a second packing ring at the inner circumferential surface 113.

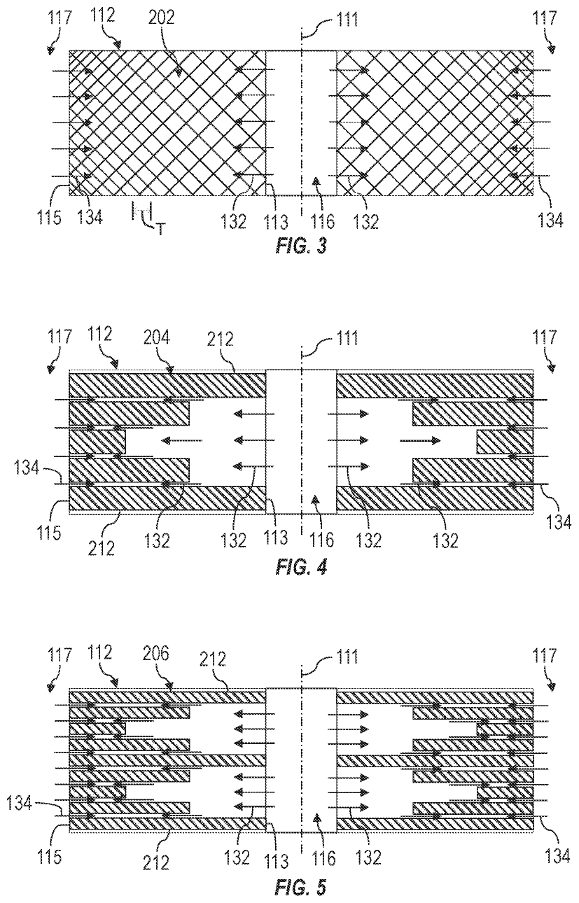

FIGS. 4 and 5 illustrate rotors with permeable packings 204, 206 that may each comprise a plurality of discs 212 disposed in a concentric and parallel manner, and spaced apart by predetermined distances, thereby permitting the passage of liquid and gas therebetween. The discs 212 may have an annular geometry, each comprising an inner radius and an outer radius. The inner radius of the discs 212 may vary, whereby the discs 212 having a larger inner radius form larger spaces (or gaps) between the discs 212. Thus, as the spacing between adjacent discs 212 decreases in the radially outward direction 132, the collective porosity of the discs 212 also decreases in the radially outward direction 132, increasingly restricting flow of the liquid through the permeable packing 204, 206 in the radially outward direction 132. In some embodiments, the permeable packings 204, 206 permit passage of liquid and gas radially through the plurality of discs 212 (hashed boxes in FIGS. 4 and 5) without permitting substantial passage of liquid and gas through distances between adjacent discs 212. The porosity of the permeable packing from the inner circumferential surface 113 to the outer circumferential surface 115 may vary axially across the rotor 112 by way of the plurality of discs 212.

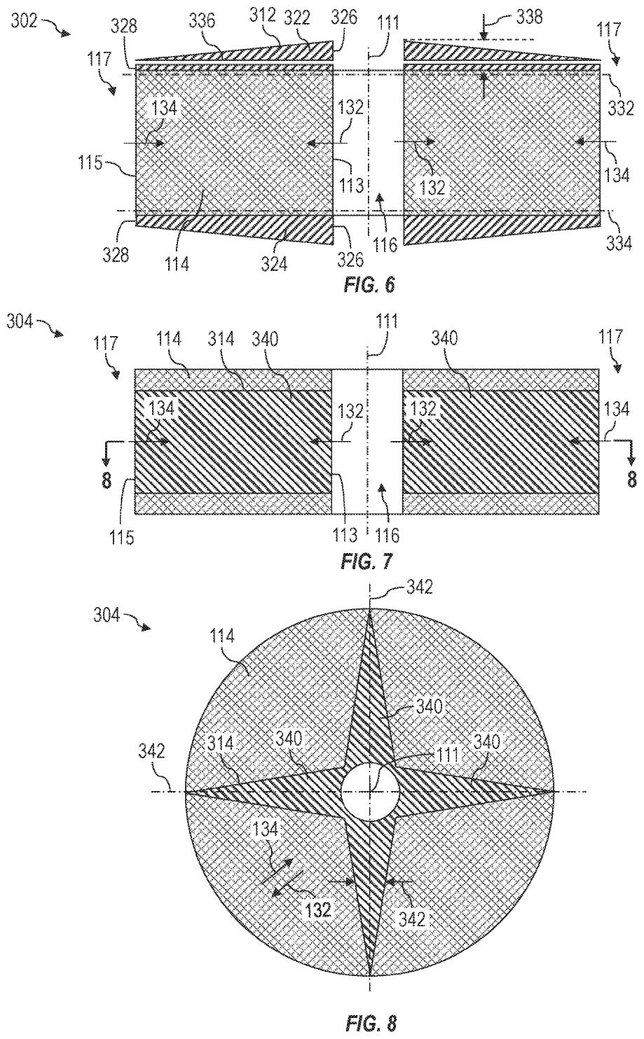

FIGS. 6 and 7 are schematic sectional side views of example implementations of rotors 302, 304, respectively, according to one or more aspects of the present disclosure. FIG. 8 is a sectional axial view of the rotor 304 shown in FIG. 7. The rotors 302, 304 may be or comprise example implementations of the rotor 112 shown in FIGS. 1 and 2, and may comprise one or more features and/or modes of operation of the rotor 112. The rotors 302, 304 may be implemented as part of the RPB reactor 100 shown in FIGS. 1 and 2. Accordingly, the following description may refer to FIGS. 1, 2, and 6-8, collectively.

Each rotor 302, 304 may be configured to be disposed within the housing 110 and operatively connect with the motor 112. Each rotor 302, 304 may comprise the permeable packing 114 configured to facilitate contact between a liquid and a gas passing through the permeable packing 114 as shown by arrows 132 and 134. Each rotor 302, 304 may further comprise a heat sink 312, 314, respectively, in contact with the permeable packing 114 and configured to transfer heat away from the permeable packing 114. Each heat sink 312, 314 may comprise a heat rate transfer gradient that increases in the radially inward direction between the outer circumferential surface 115 of the permeable packing 114 and the central axis 111, as indicated by the arrows 134. The heat sink 312, 314 may include, but is not limited to copper, aluminum, and other materials with high thermal conductivity. Each heat sink 312, 314 may be connected to or otherwise in contact with the shaft 124, which may be configured to transfer the heat away from the heat sink 312, 314. In some embodiments, the heat sink 312, 314 may have a heat rate transfer gradient that decreased in the radially inward direction between the outer circumferential surface 115 of the permeable packing 114 and the central axis 111.

The heat sink 312 may comprise an upper plate 322 extending along and in contact with an upper surface of the permeable packing 114, and a lower plate 324 extending along and in contact with a lower side surface of the permeable packing 114. Each plate 322, 324 may comprise an annular geometry having an inner circumferential surface 326 and an outer circumferential surface 328. The plates 322, 324 may have less permeability to the liquid and the gas than the permeable packing 114. The inner circumferential surface 326 may coincide with the inner circumferential surface 113 of the permeable packing 114 and the outer circumferential surface 328 may coincide with the outer circumferential surface 115 of the permeable packing 114. The upper plate 322 may coincide with or extend along a plane 332 and the lower plate 324 may coincide with or extend along a plane 334. Each plane 332, 334 may be perpendicular with respect to the central axis 111.

A fluid pathway 336 may extend through the upper plate 322 and/or the lower plate 324. The fluid pathway 336 may be configured to transfer a liquid coolant to facilitate transfer of heat away from the upper plate 322 and/or the lower plate 324. The liquid coolant through the fluid pathway 336 may be different than the liquid configured to flow through the permeable packing 114 in the radially outward direction 132. The upper plate 322 and the lower plate 324 may each comprise a thickness dimension 338 that increases in the radially inward direction between the outer circumferential surface 115 of the permeable packing 114 and the central axis 111 of the permeable packing 114, as indicated by the arrows 134.

The heat sink 314 may comprise a plurality of ribs 340 each extending through and in contact with the permeable packing 114. Each rib 340 may extend radially along a plane 342 that coincides with and/or is parallel with respect to the central axis 111. Each rib 340 may comprise a thickness dimension 342 that increases in the radially inward direction between the outer circumferential surface 115 of the permeable packing 114 and the central axis 111 of the permeable packing 114, as indicated by the arrows 134. In some embodiments, the one or more ribs 340 of the heat sink 314 are permeable to the liquid and/or gas configured to flow through the permeable packing 114. In some embodiments, the one or more ribs 340 of the heat sink 314 are impeller blades as discussed in detail below. In some embodiments, the one or more ribs 340 provide structural support for the permeable packing 114 during operation. The one or more ribs 340 coupled to the permeable packing 114 and the rotor 304 may facilitate maintenance of the porosity of the permeable packing 114 throughout a range of operating speeds of the rotor 304.

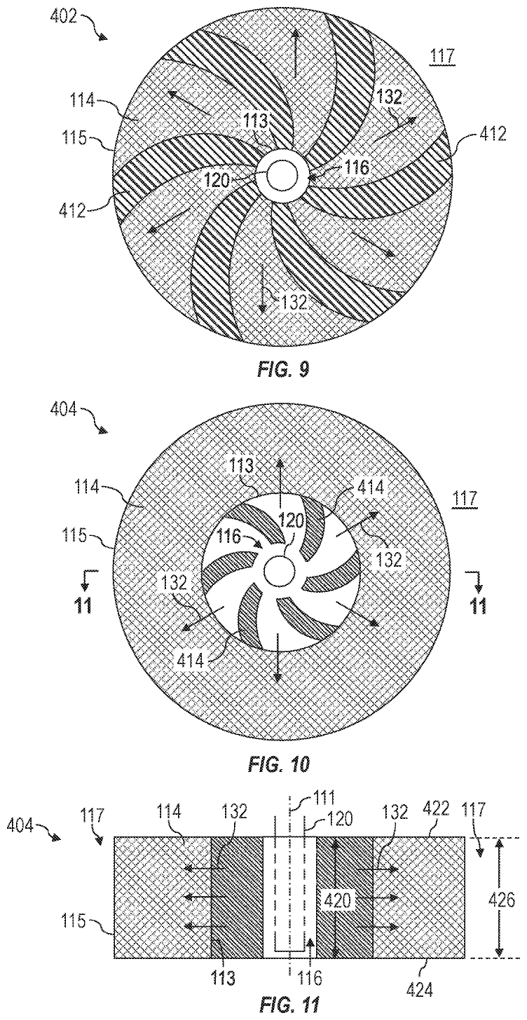

FIGS. 9 and 10 are schematic sectional axial views of example implementations of rotors 402, 404, respectively, according to one or more aspects of the present disclosure. FIG. 11 is a sectional side view of the rotor 404 shown in FIG. 10. Fach rotor 402, 404 may be or comprise an example implementation of the rotor 112 shown in FIGS. 1 and 2, and may comprise one or more features and/or modes of operation of the rotor 112. Each rotor 402, 404 may be implemented as part of the RPB reactor 100 shown in FIGS. 1 and 2. Accordingly, the following description may refer to FIGS. 1, 2, and 9-11, collectively.

Each rotor 402, 404 may be configured to be disposed within the housing 110 and operatively connect with the motor 112, such that the rotor 402, 404 rotates about the central axis 111. Each rotor 402, 404 may comprise the permeable packing 114 configured to facilitate contact between a liquid and a gas passing through the permeable packing 114. Each rotor 402, 404 may further comprise a plurality of impeller blades 412, 414, respectively, configured to force the liquid through the permeable packing 114 in the radially outward direction with respect to the central axis 111, as indicated by the arrows 132. Each plurality of the impeller blades 412, 414 may be distributed around the central axis 111. Each plurality of impeller blades 412, 414 may define the axial space 116 configured to accommodate the liquid distributor 120 and, thus, receive the liquid from the distributor 120. Thus, as each rotor 402, 404 rotates, each plurality of impeller blades 412, 414 may be configured to force the liquid from the axial space 116 in the radially outward direction through the permeable packing 114, as indicated by the arrows 132.

The permeable packing 114 of each rotor 402, 404 may comprise an annular geometry having the inner circumferential surface 113 and the outer circumferential surface 115. In some embodiments, one or more of the impeller blades 412 of the rotor 402 may extend radially between the inner circumferential surface 113 and the outer circumferential surface 115. For example, at least one of the impeller blades 412 may extend radially from the inner circumferential surface 113 to the outer circumferential surface 115. In some embodiments, each of the impeller blades 412 of the rotor 402 may extend radially from the inner circumferential surface 113 to the outer circumferential surface 115. In some embodiments, one or more of the impeller blades 412 of the rotor 402 may extend radially from the inner circumferential surface 113 without extending to the outer circumferential surface 115. In some embodiments, one or more of the impeller blades 412 of the rotor 402 may extend radially from the outer circumferential surface 115 without extending to the inner circumferential surface 113. In some embodiments, one or more of the impeller blades 412 of the rotor 402 are arranged within the permeable packing 114 without extending to either the inner circumferential surface 113 or the outer circumferential surface 115. In some embodiments, one or more of the impeller blades 414 of the rotor 404 may be located wholly within the inner circumferential surface 113, as shown in FIGS. 10 and 11. The permeable packing 114 of each rotor 402, 404 may comprise an upper axial end 422, a lower axial end 424, and an axial length (or height) 426 measured between the upper axial end 422 and the lower axial end 424. The impeller blades 412, 414 may comprise an axial length (or height) 420 extending axially along the central axis 111. The impeller blades 412, 414 may extend partially between the upper axial end 422 and the lower axial end 424 of the permeable packing 114. The impeller blades 412, 414 may instead extend the entire axial length 426 of the permeable packing 114 from the upper axial end 422 to the lower axial end 424.

FIG. 12 is a schematic sectional side view of an example implementation of a liquid distributor 502 according to one or more aspects of the present disclosure. The distributor 502 may be an example implementation of the distributor 120 shown in FIGS. 1 and 2, and may comprise one or more features and/or modes of operation of the distributor 120. The distributor 502 may be implemented as part of the RPB reactor 100 shown in FIGS. 1 and 2. Accordingly, the following description may refer to FIGS. 1, 2, and 12, collectively.

The distributor 502 may be disposed within the axial space 116. The distributor 502 may be or comprise a tubular member, having an outer surface 504 and an inner surface 506. The inner surface 506 may define a central bore (or fluid pathway) 508 fluidly connected with the liquid inlet 118. The distributor 502 may further comprise a plurality of lateral bores (or fluid pathways) 510 each extending radially with respect to the central axis 111 between the inner surface 506 and the outer surface 504, thereby fluidly connecting the central bore 508 and the axial space 116. Accordingly, the central bore 508 and the lateral bores 510 may collectively facilitate the transfer of liquid from the liquid inlet 118 to the axial space 116, as indicated by arrows 512, such that the liquid can pass through the permeable packing 114. The increased wall thickness of the distributor 502 can also facilitate increased transfer of heat from the liquid into and through the distributor 502. Thus, the distributor 502 may also be used as a heat sink. The lateral bores 510 may be configured to direct the liquid to the permeable packing 114 at rates and pressures that enable the liquid to flow through the permeable packing 114 without flooding the axial space of the rotor. Moreover, the rotor speed of the RPB reactor 100 may be controlled based at least in part on the flow of liquid to the distributor 502 to reduce or eliminate flooding of the RPB reactor. Additionally or in the alternative, the flow of the liquid to the distributor 502 may be controlled based at least in part on the rotor speed of the RPB reactor 100. For example, the flow of liquid to the distributor 502 may increase for greater rotor speeds of the RPB reactor 100 and greater flow rates of the gas to the RPB reactor 100, thereby increasing the interaction between the liquid and the gas within the RPB reactor 100.

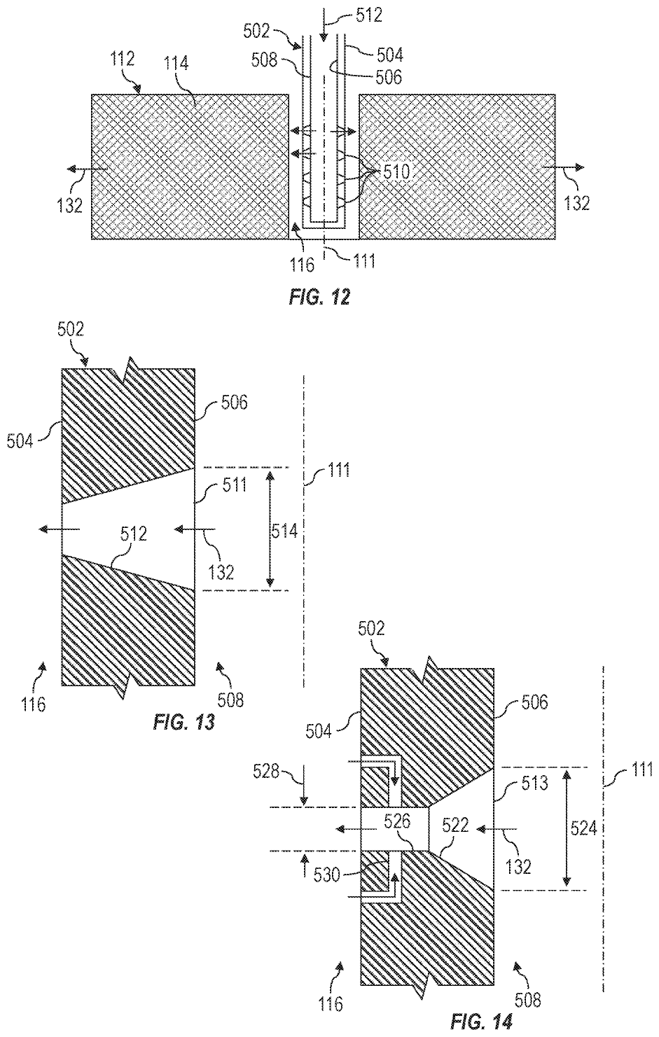

FIG. 13 is an enlarged view of an example implementation of a lateral bore 511 according to one or more aspects of the present disclosure. The lateral bore 511 may be an example implementation of the lateral bores 510 shown in FIG. 12, and may comprise one or more features and/or modes of operation of the lateral bores 510. The lateral bore 511 may be implemented as part of the liquid distributor 502 shown in FIG. 12, and the liquid distributor 502 may be implemented as part of the RPB reactor 100 shown in FIGS. 1 and 2. Accordingly, the following description refers to FIGS. 1, 2, 12, and 13, collectively. In some embodiments, the lateral bores 510 are axially arranged with a plurality of discs 212 of the permeable packing 114 as discussed above with FIGS. 4 and 5 to achieve a desired porosity gradient. In some embodiments, the lateral bores 510 are controlled and axially arranged with a plurality of discs to achieve a desired porosity gradient.

Each lateral bore 511 may comprise or be defined by an inner surface 512 having an inner diameter 514 that decreases (or is tapered) in the radially outward direction with respect to the central axis 111, as indicated by the arrows 132. The tapered lateral bores 511 may increase pressure and, thus, velocity of the liquid passing therethrough.

FIG. 14 is an enlarged view of an example implementation of a lateral bore 513 according to one or more aspects of the present disclosure. The lateral bore 513 may be an example implementation of the lateral bores 510 shown in FIG. 12, and may comprise one or more features and/or modes of operation of the lateral bores 510. The lateral bore 513 may be implemented as part of the liquid distributor 502 shown in FIG. 12, and the liquid distributor 502 may be implemented as part of the RPB reactor 100 shown in FIGS. 1 and 2. Accordingly, the following description refers to FIGS. 1, 2, 12, and 14, collectively.

Each lateral bore 513 may comprise or be defined by an inner surface 522 having an inner diameter 524 that decreases (or is tapered) in the radially outward direction with respect to the central axis 111, as indicated by the arrows 132, and an inner surface 526 having an inner diameter 528 that is constant in the radially outward direction with respect to the central axis 111. Thus, each lateral bore 513 may comprise a first portion having the first inner diameter 524 that decreases in the radially outward direction with respect to the central axis 111 and a second portion having the inner diameter 528 that is constant in the radially outward direction with respect to the central axis 111. The tapered lateral bores 513 may increase pressure and, thus, velocity of the liquid passing therethrough.

The liquid distributor 502 may further comprise a plurality of intermediate bores 530 each extending between the outer surface 504 and a corresponding one of the inner surfaces 526, thereby fluidly connecting the axial space 116 and a corresponding one of the lateral bores 513 at an intermediate location of the lateral bore 513 between the inner surface 506 and the outer surface 504. Each intermediate bore 530 may operate as a venturi tube configured to receive the liquid within the axial space 116 and transfer the liquid back into a corresponding one of the lateral bores 513 at an intermediate location of the lateral bore 513 between the inner surface 506 and the outer surface 504, thereby increasing velocity of the liquid passing through the lateral bores 513.

In view of the entirety of the present disclosure, a person having ordinary skill in the art will readily recognize that the present disclosure introduces an apparatus comprising a rotating packed bed reactor that comprises: a housing; a motor; and a rotor disposed within the housing and operatively connected with the motor, wherein the rotor comprises a permeable packing configured to facilitate contact between a liquid and a gas passing through the permeable packing, and wherein the permeable packing comprises a porosity gradient that decreases in a radially outward direction between a central axis of the permeable packing and an outer circumferential surface of the permeable packing.

The permeable packing may comprise particulate material.

The permeable packing may comprise a mesh.

The permeable packing may comprise a plurality of annular discs disposed in a concentric and parallel manner, wherein each of the annular discs may comprise an inner radius and an outer radius, and wherein the inner radius of the discs may vary.

The present disclosure also introduces an apparatus comprising a rotating packed bed reactor that comprises: a housing; a motor; and a rotor disposed within the housing and operatively connected with the motor. The rotor comprises: a permeable packing configured to facilitate contact between a liquid and a gas passing through the permeable packing; and a heat sink in contact with the permeable packing and configured to transfer heat away from the permeable packing, wherein the heat sink comprises a heat rate transfer gradient that increases in a radially inward direction between an outer circumferential surface of the permeable packing and a central axis of the permeable packing.

The heat sink may comprise: a first plate extending along and in contact with a first surface of the permeable packing; and a second plate extending along and in contact with a second surface of the permeable packing. The first and second plates may each extend along a plane that is perpendicular with respect to the central axis of the permeable packing. The first and second plates may each comprise a thickness dimension that increases in the radially inward direction between the outer circumferential surface of the permeable packing and the central axis of the permeable packing.

A fluid pathway may extend through the heat sink. The fluid pathway may be configured to transfer a liquid coolant to therefore transfer heat away from the heat sink.

The heat sink may comprise a plurality of ribs each extending through and in contact with the permeable packing. Each rib may extend along a plane that coincides with, or is parallel with respect to, the central axis of the permeable packing. A thickness dimension of each rib may increase in the radially inward direction between the outer circumferential surface of the permeable packing and the central axis of the permeable packing.

The rotating packed bed reactor may comprise a shaft connecting the motor with the rotor, wherein the heat sink may be connected to the shaft and the shaft may be configured to transfer the heat away from the heat sink.

The present disclosure also introduces an apparatus comprising a rotating packed bed reactor that comprises: a housing; a motor; and a rotor disposed within the housing and operatively connected with the motor, wherein the rotor is configured to rotate about a central axis. The rotor comprises: a permeable packing configured to facilitate contact between a liquid and a gas passing through the permeable packing; and a plurality of impeller blades configured to force the liquid through the permeable packing in a radially outward direction with respect to the central axis.

The impeller blades may be distributed around an axial space, the axial space may extend along the central axis, and the axial space may be configured to receive the liquid.

The permeable packing may comprise an annular geometry having an inner circumferential surface and an outer circumferential surface. At least one of the impeller blades may be located wholly within the inner circumferential surface.

The permeable packing may comprise an annular geometry having an inner circumferential surface and an outer circumferential surface. At least one of the impeller blades may extend at least partially between the inner circumferential surface and the outer circumferential surface.

The permeable packing may comprise a first axial end and a second axial end. At least one of the impeller blades may extend at least partially between the first axial end and the second axial end.

The present disclosure also introduces an apparatus comprising a rotating packed bed reactor that comprises: a housing comprising a gas inlet and a liquid inlet; a motor; a rotor disposed within the housing and operatively connected with the motor; and a liquid distributor. The rotor is configured to rotate about a central axis and comprises a permeable packing configured to facilitate contact between a liquid and a gas passing through the permeable packing. The permeable packing comprises an annular geometry having an inner circumferential surface defining an axial space that extends along the central axis. The liquid distributor is disposed within the axial space and comprises: an outer surface; an inner surface defining a central bore fluidly connected with the liquid inlet; and a plurality of lateral bores each extending between the outer surface and the inner surface thereby fluidly connecting the central bore and the axial space, wherein each lateral bore comprises an inner diameter that decreases in a radially outward direction with respect to the central axis.

The inner diameter may be a first inner diameter, the inner surface may be a first inner surface, and each of the lateral bores may be defined by: a second inner surface having the first inner diameter that decreases in the radially outward direction with respect to the central axis; and a third inner surface having a second inner diameter that is constant in the radially outward direction with respect to the central axis.

The inner surface may be a first inner surface and the liquid distributor may comprise: a plurality of second inner surfaces each defining a corresponding one of the lateral bores; and a plurality of intermediate bores each extending between the outer surface and a corresponding one of the second inner surfaces thereby fluidly connecting the axial space and a corresponding one of the intermediate bores between the first inner surface and the outer surface.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the scope of the present disclosure.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. An apparatus comprising:
a rotating packed bed reactor comprising:
a housing;
a motor; and
a rotor disposed within the housing and operatively connected with the motor, wherein the rotor comprises:
a permeable packing configured to facilitate contact between a liquid and a gas passing through the permeable packing; and
a heat sink in contact with the permeable packing and configured to transfer heat away from the permeable packing, wherein the heat sink comprises a heat rate transfer gradient in a radially inward direction between an outer circumferential surface of the permeable packing and a central axis of the permeable packing.

2. The apparatus of claim 1 wherein the heat sink comprises:
a first plate extending along and in contact with a first surface of the permeable packing; and
a second plate extending along and in contact with a second surface of the permeable packing.

3. The apparatus of claim 2 wherein the first and second plates each extend along a plane that is perpendicular with respect to the central axis of the permeable packing.

4. The apparatus of claim 2 wherein the heat rate transfer gradient increases in the radially inward direction, and the first and second plates each comprise a thickness dimension that increases in the radially inward direction between the outer circumferential surface of the permeable packing and the central axis of the permeable packing.

5. The apparatus of claim 1 wherein:
a fluid pathway extends through the heat sink; and
the fluid pathway is configured to transfer a liquid coolant to therefore transfer heat away from the heat sink.

6. The apparatus of claim 1 wherein the heat sink comprises a plurality of ribs each extending through and in contact with the permeable packing.

7. The apparatus of claim 6 wherein each rib extends along a plane that coincides with, or is parallel with respect to, the central axis of the permeable packing.

8. The apparatus of claim 6 wherein a thickness dimension of each rib increases in the radially inward direction between the outer circumferential surface of the permeable packing and the central axis of the permeable packing.

9. The apparatus of claim 6, wherein at least one rib of the plurality of ribs axially extends partially along the central axis between an upper axial end and a lower axial end of the permeable packing.

10. The apparatus of claim 1 wherein:
the rotating packed bed reactor further comprises a shaft connecting the motor with the rotor;
the heat sink is connected to the shaft; and
the shaft is configured to transfer the heat away from the heat sink.

11. The apparatus of claim 1, wherein the permeable packing comprises an annular geometry having an inner circumferential surface defining an axial space, wherein the rotating packed bed reactor comprises a liquid distributor within the axial space, the liquid distributor comprising:
an outer surface;
an inner surface defining a central bore fluidly connected with the liquid inlet; and
a plurality of lateral bores each extending between the outer surface and the inner surface thereby fluidly connecting the central bore and the axial space, wherein each lateral bore comprises an inner diameter that decreases in a radially outward direction with respect to the central axis.

12. The apparatus of claim 11, wherein:
the inner diameter is a first inner diameter;
the inner surface is a first inner surface; and
each of the lateral bores is defined by:
a second inner surface having the first inner diameter that decreases in the radially outward direction with respect to the central axis; and
a third inner surface having a second inner diameter that is constant in the radially outward direction with respect to the central axis.

13. The apparatus of claim 1, wherein the liquid comprises an amine and the gas comprises carbon dioxide, wherein the liquid is configured to absorb carbon dioxide from the gas.

14-20. (canceled)
